(19) United States
(12) Patent Application Publication
(10) Pub. No.: US 2017/0284156 A1
(43) Pub. Date: Oct. 5, 2017

(54) SECURING DEVICE FOR SECURING WIRES OF WINDOW SHADES

(71) Applicant: CHING FENG HOME FASHIONS CO., LTD., Fuxing Shiang (TW)

(72) Inventors: SHENG YING HSU, Fuxing Shiang (TW); CHUN JAN HSU, Fuxing Shiang (TW)

(21) Appl. No.: 15/461,395

(22) Filed: Mar. 16, 2017

(30) Foreign Application Priority Data
Mar. 29, 2016 (TW) 105204330

(51) Int. Cl. E06B 9/326

(52) U.S. Cl. CPC E06B 9/326

(57) ABSTRACT

A securing device for a window shade includes a securing member connected to the bottom bar of the window shade, and the securing member has a first end and a second end. The first end of the securing member faces the bottom bar, and the second end of the securing member faces a direction away from the bottom bar. The second end has at least one securing slot defined axially therein. The width of the at least one securing slot is gradually narrowed from the second end toward the first end of the securing member. The narrowest end of the at least one securing slot is a clamping notch which is used to clamp the wire of the window shade.

### BACKGROUND OF THE INVENTION

### 1. Fields of the invention

The present invention relates to a window shade, and more particularly, to a securing member located at the bottom bar of the shade so as to secure the wire extending through the slots of the window shade.

### 2. Descriptions of Related Art

The conventional window shade known to applicant is disclosed in FIGS. 6 and 7, and comprises multiple slats and at least one wire 56 extends through the slats and is secured to a securing member 40 located in the bottom bar 50 of the window shade.

The bottom bar 50 includes at least one hole 51 through which the at least one wire 56 extends. A tubular member 52 is engaged with the at least one hole 51. The securing member 40 has a passage 41. The distal end of the at least one wire 56 extends through the passage 41 from top to bottom of the securing member 40, and is bent upward and extends through the passage 41 again. The distal end of the at least one wire 56 then extends beyond the bottom of the securing member 40. The at least wire 56 is pulled downward to tie the at least one wire 56 to the securing member 40. The securing member 40 together with the at least one wire 56 are then fitted into the tubular member 52 to position the at least one wire 56 to the bottom bar 50.

However, there is a limited contact area between the at least one wire 56 and the bottom of the securing member 40, and the securing member 40 does not have a proper fastening or securing feature to secure the at least one wire 56, so that the at least one wire 56 can easily loose. The loosened at least one wire 56 causes the slats 55 to be inclined relative to the floor when the window shade expands. Furthermore, the loosened at least one wire 56 also causes the bottom bar 50 to be inclined relative to the floor when the window shade collected.

The present invention intends to provide a securing device which has a securing member located at the bottom bar of the shade so as to secure the wire extending through the slats of the window shade.

### SUMMARY OF THE INVENTION

The present invention relates to a securing device for a window shade and comprises a securing member connected to the bottom bar of the window shade. The securing member has a first end and a second end. The first end of the securing member faces the bottom bar, and the second end of the securing member faces a direction away from the bottom bar. The second end has at least one securing slot defined axially therein. The width of the at least one securing slot is gradually narrowed from the second end toward the first end of the securing member. The narrowest end of the at least one securing slot is a clamping notch which is used to clamp the wire of the window shade.

Preferably, the at least one securing slot is an inverted V-shaped slot.

Preferably, there are two securing slots defined in the second end of the securing member. The two securing slots are located diametrically opposite from each other.

The present invention has the advantages which are that the second end has at least one securing slot defined axially therein. The narrowest end of the at least one securing slot is a clamping notch which is used to clamp the wire of the window shade. When the wire extends through the securing member and is bent upward, the wire is clamped by the clamping notch because of the gradually narrowed width of the clamping notch. Therefore, the wire can be secured relative to the securing member and does not loose. The specific feature ensures that the slats and the bottom bar are always maintained horizontally.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the securing member of the present invention connected the bottom bar of the window shade;

FIG. 2 is an exploded view of the disclosure in FIG. 1;

FIG. 3 is an enlarged view to show that the wire is secured to the securing member of the present invention;

FIG. 4 shows the cross sectional view of the cooperation of the wire and the securing member of the present invention;

FIG. 5 shows that the wire is clamped in the clamping notch of the securing slot of the securing member of the present invention;

FIG. 6 shows a cross sectional view of the cooperation of the wire and the securing member of a conventional window shade, and

FIG. 7 is an enlarged view to show that the wire is secured to the conventional securing member.

### DETAILED DESCRIPTION OF THE PREFERRED EMBODIMENT

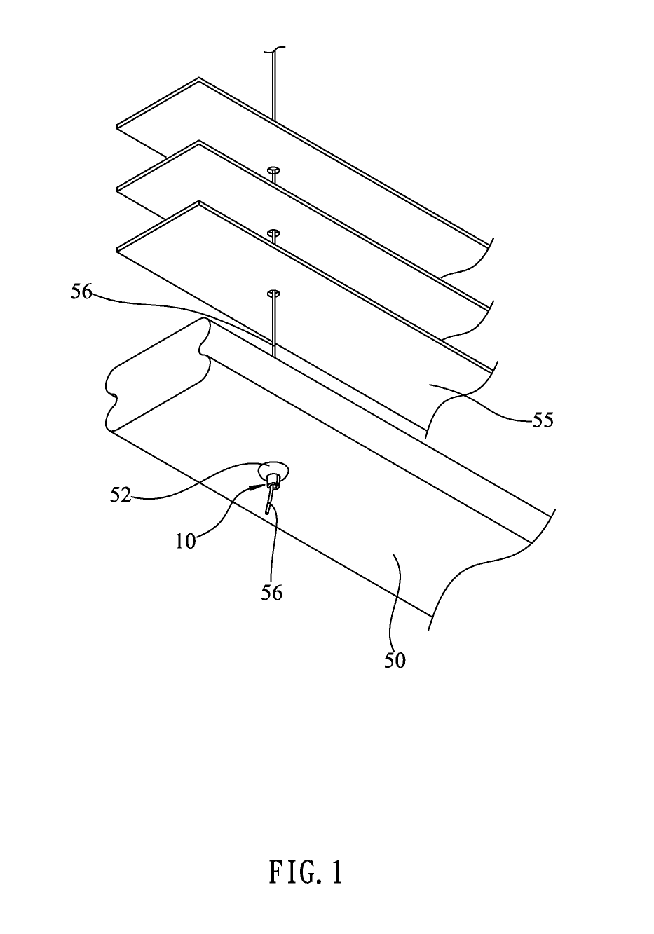

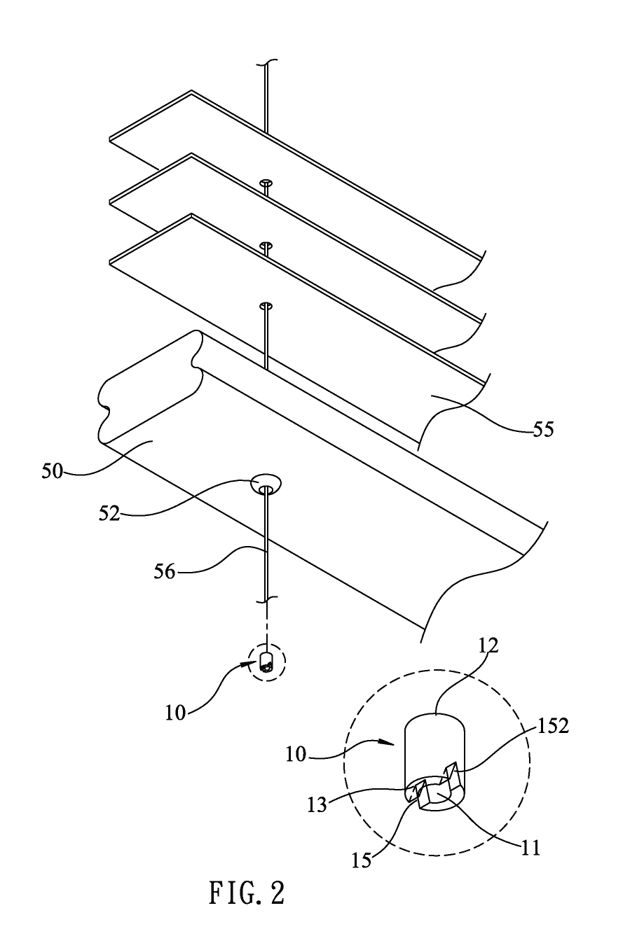

Referring to FIGS. 1 and 2, the securing device of the present invention comprises a securing member 10 which is a tubular member with a passage 11 defined axially therethrough. The securing member 10 is connected to the bottom bar 50 of a window shade. The securing member 10 has a first end 12 and a second end 13, wherein the first end 12 of the securing member 10 faces the bottom bar 50, and the second end 13 of the securing member 10 faces a direction that is away from the bottom bar 50. The second end 13 has at least one securing slot 15 defined axially therein. In this embodiment, there are two securing slots 15 defined in the second end 13 of the securing member 10. The two securing slots 15 are located diametrically opposite from each other. Each of the securing slots 15 is an inverted V-shaped slot. The width of the each securing slot 15 is gradually narrowed from the second end 13 toward the first end 12 of the securing member 10. The narrowest end of each of the securing slots 15 is a clamping notch 152 which is featured to clamp a wire 56 extending through the slats 55 and the bottom bar 50 of the window shade.

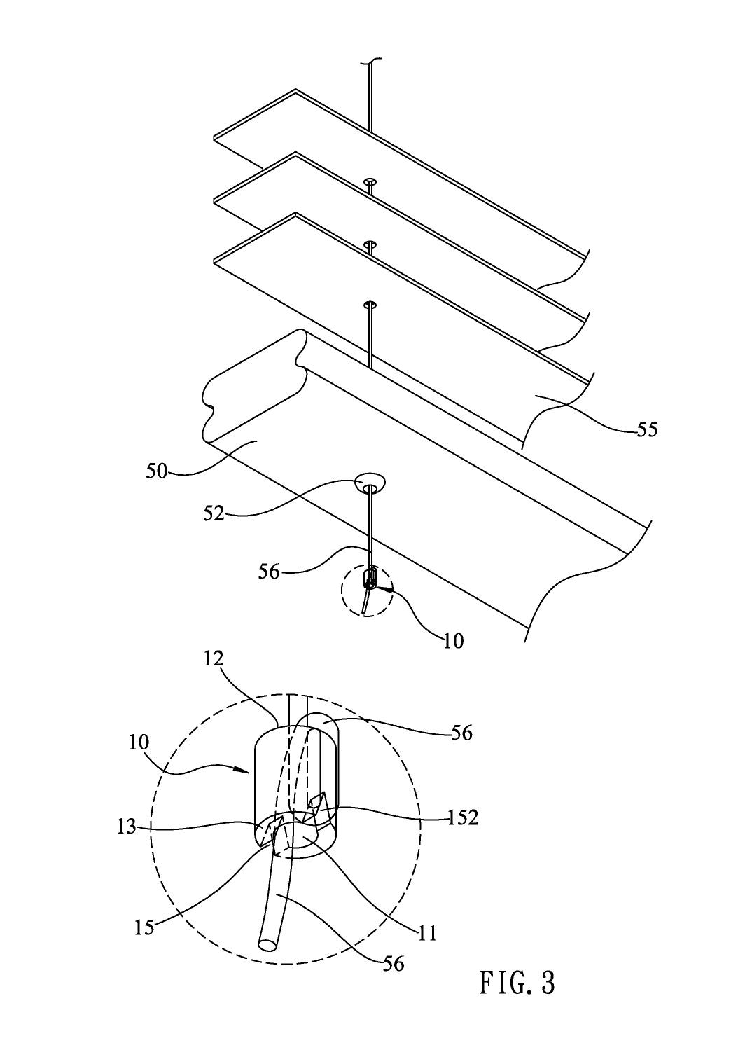

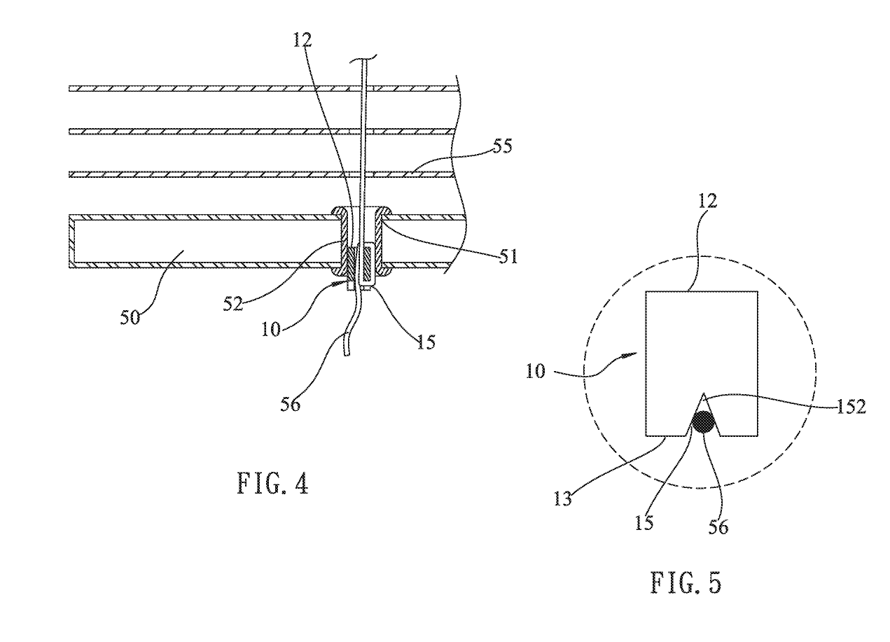

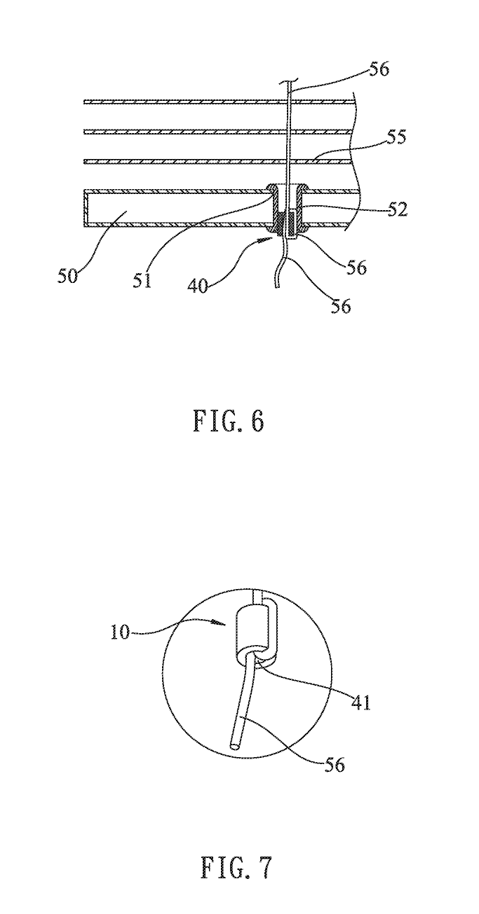

As shown in FIGS. 3 and 4, a tubular member 52 is engaged with the hole 51 of the bottom bar 50. The distal end of the wire 56 extends through the passage 11 from the first end 12 and extends beyond the second end 13 of the securing member 10. The distal end of the wire 56 is then engaged with one of the securing slots 15 and bent upward. The distal end of the wire 56 then enters into the passage 11 again from the first end 12 and comes out from the second end 13. The wire 56 is pulled tightly in the axial direction of the securing member 10. The securing member 10 and the wire 56 are together inserted into the tubular member 52. The securing member 10 is squeezed inward to secure the wire 56.

It is noted when the wire 56 is engaged with the securing slot 15, the wire 56 is securely clamped by the clamping notch 152 which squeezes the wire 56 and secures the wire 56 to ensure that the wire 56 does not loose. Therefore, the slats and the bottom bar 50 are always kept in horizontal direction.

While we have shown and described the embodiment in accordance with the present invention, it should be clear to those skilled in the art that further embodiments may be made without departing from the scope of the present invention.

What is claimed is:

1. A securing device for a window shade, and comprising:
a securing member which is adapted to be connected to a bottom bar of a window shade, the securing member having a first end and a second end, the first end of the securing member adapted to face the bottom bar, the second end of the securing member adapted to face a direction away from the bottom bar, the second end having at least one securing slot defined axially therein, a width of the at least one securing slot being gradually narrowed from the second end toward the first end of the securing member, a narrowest end of the at least one securing slot being a clamping notch which is adapted to clamp a wire of the window shade.

2. The securing device as claimed in claim 1, wherein the at least one securing slot is an inverted V-shaped slot.

3. The securing device as claimed in claim 1, wherein there are two securing slots defined in the second end of the securing member, the two securing slots are located diametrically opposite from each other.
